(19) United States
(12) Patent Application Publication
(10) Pub. No.: US 2021/0136572 A1
(43) Pub. Date: May 6, 2021

(54) SYSTEM AND METHOD FOR INCIDENT RECONSTRUCTION UTILIZING V2X COMMUNICATIONS

(71) Applicant: BAE Systems Information and Electronic Systems Integration Inc., Nashua, NH (US)

(72) Inventors: Jonathan P. Ingraham, Pelham, NH (US); Rudra Chakravorty, Nashua, NH (US); Tate J. Keegan, Candia, NH (US)

(73) Assignee: BAE Systems Information and Electronic Systems Integration Inc., Nashua, NH (US)

(21) Appl. No.: 16/635,783

(22) PCT Filed: Jul. 30, 2018
(86) PCT No.: PCT/US2018/044355

§ 371 Date: Jan. 31, 2020

Related U.S. Application Data
(60) Provisional application No. 62/540,264, filed on Aug. 2, 2017.

(51) Int. Cl. H04W 12/03; H04W 12/069; H04W 12/63; H04W 12/65; H04W 4/40; H04W 12/04

(52) U.S. Cl. CPC H04W 12/03; H04W 12/069; H04W 12/04; H04W 12/65; H04W 4/40; H04W 12/63

(57) ABSTRACT

A system and method for gathering and communicating at least one related data that is cryptographically verifiable and authenticated to use in at least one reconstruction is described. One example includes V2X device encryption provisioning; operating vehicle V2X communications; and storing all V2X data in memory. If at least one occurs: send a final request for data logs from any other V2X in the vicinity. Ensure logs are sent using signed & encrypted protocol. Record black box data; combine stored V2X data with black box data & storing to a file. Apply cryptographic protections to the file; up/down load the file from each vehicle. Recreate the at least one in 3D w/simulation software. In embodiments, reconstruction comprises fault determination.

### RELATED APPLICATIONS

This application claims the benefit of U.S. Provisional Application No. 62/540,264 filed Aug. 2, 2017, which is herein incorporated by reference in its entirety for all purposes. U.S. Provisional Application 62/503,003 filed May 8, 2017, U.S. Provisional Application No. 62/514,266 filed Jun. 2, 2017, PCT Application No. PCT/US2018/031602 Filed May 8, 2018, and PCT Application No. PCT/US2018/035671 Filed Jun. 1, 2018 are herein incorporated by reference in their entireties for all purposes.

### FIELD OF THE DISCLOSURE

Embodiments relate to a system and method for gathering and communicating incident-related data that is cryptographically verifiable and authenticated to use in incident (including accident) and other similar event reconstruction.

### BACKGROUND

Whenever there is an incident such as a vehicle accident (vehicle includes land based, airborne and sea-based vehicles), crime, terrorist act, or other event that requires reconstruction, it is difficult to gather reliable information. Current technology has allowed for an array of cameras and sensors, however there lacks a mechanism to reliably collect and authenticate the data.

Related to vehicle accidents, the current methods for assigning fault in automobile accidents are based on witness or participant testimony or forensic accident reconstruction. These methods are data limited and do not fully account for actual vehicle and surrounding infrastructure state or status. This drives insurance and legal costs when disputes arise. While existing patents and applications (each of which is herein incorporated by reference in its entirety for all purposes) such as U.S. Pat. Nos. 8,954,226, 9,361,650, and U.S. Published Patent Application 2015/0112504 pertain to synchronization, collection, and visualization of vehicle data for use in accident reconstruction, they do not contain any method for validating the authenticity of the data. Data validation, authenticity, and fault assignment are topics of interest to the US Department of Transportation, especially as addressed in their September 2016 self-driving vehicle guidance.

V2X (vehicle to everything) protocols facilitate bi-directional vehicle to vehicle, and vehicle to infrastructure communications. They are envisioned to help increase safety and reduce congestion on the road by allowing vehicles and infrastructure to communicate. However, there are roadblocks to using V2X. For example, currently the adoption of V2X via the Dedicated Short Range Communications (DSRC) protocol is in question due to cost, utility, lack of government mandate, and security challenges. Taking the scenario of automatic braking or accident avoidance, the data must be trusted such that there are assurances it is from a valid sensor and not a hacker. Similarly, transmitted data used in accident reconstruction must have assurances that it is from a valid sensor and not a hacker. Without security protection measures, a nonvalid node could be on the network, sending malicious traffic and appearing to be authentic.

What is needed is a cryptographically verifiable and automated system and method for gathering and communicating incident-related data that does not rely on individual memory or traditional forensic accident reconstruction methods and guarantees its authenticity; further providing fault assignment.

### SUMMARY

An embodiment provides a system for cryptographically verifiable and authenticated entity incident reconstruction comprising sending and receiving communication data (140, 150) by at least one transceiver device (305) on one or more entities (105, 110, 115, 120, 125, 130, 410); storing, in at least one memory storage device (320), data received and sent from the entities for a time period, wherein the data comprises a plurality of entries (415); upon occurrence of an incident (420) at an incident location at an incident time involving at least one incident entity: sending a final request for data logs from at least one other communication-connected entity in a vicinity of the incident (425); if there are data logs, processing the data logs from the at least one other communication-connected entity, wherein the data logs are sent using at least one of a signed and encrypted protocol whereby an originating entity can be determined (410); sending a request for stationary communication-connected entities in the vicinity to store off their data, if any, for a final request time period; storing all the data and data logs in the at least one memory storage device with the recorded data and storing to a file (435) in memory; applying cryptographic protections to the file such that confidentiality, authenticity and integrity can be determined (440); downloading the file from each entity (445); and using simulation software with the file from each entity, recreate the incident (450). In embodiments the data is combined with other databases comprising at least one of most wanted list, terror watch list, driving history, arrest and conviction records, financial record/credit score, vehicle recall history, vehicle repair history, and vehicle accident history. In other embodiments, the entity is at least one of a vehicle (210), a drone, an aircraft, a vessel, and a stationary object (125, 130). In subsequent embodiments the data comprises vehicle to everything (V2X) communications (140), and sending and receiving comprises Dedicated Short Range Communications (DSRC). Additional embodiments comprise a step of device encryption provisioning (405) comprising generating an Identification Number—Key for one or more entities (505); applying the Identification Number—Key to components of the one or more entities (510); receiving input for the one or more entities (515); validating authenticity of at least one of the input and the one or more entities (520); performing operation of the input if validated (525); and logging the operation (530), whereby the authenticity of the one or more entities is immutable and cryptographically verified. In another embodiment, the step of sending and receiving data by at least one transceiver device on at least one entity (410) comprises operating a vehicle's vehicle to everything (V2X) key management in a securely configured V2X communications environment comprising: a vehicle V2X device (605) communicating with other V2X devices by receiving communications from the other V2X devices (610); the vehicle V2X device (605) further communicates with the other V2X devices by sending communications to the other V2X devices (615); the V2X data received from external V2X devices is verified to be authentic (620); data which cannot be verified as authentic are discarded, if received data is determined to be authentic, the V2X data they contain is processed (625); the V2X data is either communicated to a vehicle CPU (630), stored (415), or added to outgoing V2X messages to be transmitted or propagated (640). For a following embodiment, the step of ensuring, at the at least one other communication-connected entity, that the data logs are sent using at least one of a signed and encrypted protocol whereby an originating entity can be determined (410) comprises receiving messages from external V2X devices (705); authenticating messages (710); if the message or its contents are not authentic, discard it and log activities (725); if the message and its contents are authentic, read the data (715) for use by the vehicle V2X device for further processing (720) or storage. In subsequent embodiments, the step of applying cryptographic protections to the file such that confidentiality, authenticity and integrity can be determined (440) comprises creating a record (805); adding all data to the record (810); encrypting and signing the record (815); and saving the record (820), whereby the confidentiality of logged data is protected. In additional embodiments, applying cryptographic protections to the file such that confidentiality, authenticity and integrity can be determined (445) comprises receiving data (905); recreating at least one key (910); decrypting and verifying file (915); processing data (920); and logging activities (925). Ensuing embodiments further comprise a step of opting-in by a controller of a respective entity to share the data. In included embodiments the step of storing (415) comprises non-volatile memory (NVM) (330) and a circular volatile buffer (325). Yet further embodiments comprise recording black box data from at least one of the incident entity and the communication-connected entity in a vicinity of the incident. In related embodiments, downloading the file from each entity (445) comprises an upload via Over The Air (OTA) to a cloud (340). For further embodiments the vicinity of the incident is defined as a line of sight distance from the incident location to each stationary entity within a line of sight of the incident location, and for each mobile entity, a distance from the incident location to each mobile entity within a line of sight of the incident at the incident time; and the step of using simulation software with the file from each entity, recreating the incident (450) comprises 2D or 3D.

Another embodiment provides a method for cryptographically verifiable and authenticated entity incident reconstruction comprising sending and receiving communication messages by at least one entity (410); storing (320) all data received and sent from a plurality of the entities for a time period, wherein the data comprises a plurality of entries (415); upon occurrence of an incident (420) at an incident location at an incident time involving at least one incident entity: sending a final request for data logs from at least one other communication-connected entity in a vicinity of the incident (425); ensuring, at the at least one other communication-connected entity, that the data logs are sent using at least one of a signed and encrypted protocol whereby an originating entity can be determined (410); sending a request for stationary communication-connected entities in the vicinity to store off their data for a final request time period; combining all the data stored in the at least one memory storage device with the recorded data and storing to a file (435) in memory; applying cryptographic protections to the file such that confidentiality, authenticity and integrity can be determined (440); downloading the file from each entity (445); and using simulation software with the file from each entity, recreate the incident in 2D (450). For yet further embodiments, the incident occurrence comprises at least one of a designation by an operator of an entity; or an accident. For more embodiments, the incident occurrence (420) comprises an accident indicated by damage indicated by a signal designating a deployment of an airbag. In continued embodiments the incident entity is at least one entity directly associated with the incident. Additional embodiments further comprise determining fault or circumstances from the incident recreation results, wherein the at least one incident entity is at least one entity sustaining damage at about the incident location at about the incident time.

A yet further embodiment provides a system for cryptographically verifiable and authenticated entity incident reconstruction comprising sending and receiving communication messages by at least one transceiver device on at least one entity (410); storing, in at least one memory storage device (320) on each entity, all data received and sent from a plurality of entities for a time period, wherein the time period is in a range of about 30 to 120 seconds before and after the incident time, and wherein the data comprises a plurality of entries (415); the data comprising a plurality of data relating to maps (215), traffic lights (220), cameras (225), ultrasonic/radio frequency (230), LIDAR (235), weather (240), traffic conditions (245), steering (250), braking (255), velocity (260), and engine parameters (265); upon occurrence of an incident (420) at an incident location at an incident time involving at least one incident entity: sending, by the incident entity, a final request for data logs from at least one other communication-connected entity in a vicinity of the incident (425); ensuring at the at least one other communication-connected entity, that the data logs are sent using at least one of a signed and encrypted protocol whereby an originating entity can be determined (410); sending a request for stationary communication-connected entities in the vicinity to store off their data for a final request time period, wherein the final request time period is in a range of about 30 to 120 seconds before and after the incident time; combining all the data stored in the at least one memory storage device with the recorded data logs and storing to a file (435) in memory wherein the data stored to memory is contained in the final request data logs; applying cryptographic protections to the file such that confidentiality, authenticity and integrity can be determined (440); downloading the file from each entity (445) wherein the downloaded file comprises data stored off from stationary entities; and using simulation software with the file from each entity, recreate the incident (450).

### BRIEF DESCRIPTION OF THE DRAWINGS

FIG. 1 depicts an incident reconstruction data collection environment utilizing V2X communications configured in accordance with an embodiment.

FIG. 2 depicts a vehicle V2X environment configured in accordance with an embodiment.

FIG. 3 depicts functional modules configured in accordance with an embodiment.

FIG. 4 depicts high level flow chart of steps configured in accordance with an embodiment.

FIG. 5 depicts V2X device encryption provisioning configured in accordance with an embodiment.

FIG. 6 depicts operating vehicle V2X communications configured in accordance with an embodiment.

FIG. 7 depicts ensuring logs are received using signed & encrypted protocol configured in accordance with an embodiment.

FIG. 8 depicts applying cryptographic protections to files configured in accordance with an embodiment.

FIG. 9 depicts unlocking, decrypting, & recreating incident in 2D or 3D w/simulation software configured in accordance with an embodiment.

FIG. 10 depicts steps for processing data after an incident to recreate incident in 2D or 3D in accordance with an embodiment.

These and other features of the present embodiments will be understood better by reading the following detailed description, taken together with the figures herein described. The accompanying drawings are not intended to be drawn to scale. For purposes of clarity, not every component may be labeled in every drawing.

### DETAILED DESCRIPTION

The features and advantages described herein are not all-inclusive and, in particular, many additional features and advantages will be apparent to one of ordinary skill in the art in view of the drawings, specification, and claims. Moreover, it should be noted that the language used in the specification has been selected principally for readability and instructional purposes, and not to limit in any way the scope of the inventive subject matter. The invention is susceptible of many embodiments. What follows is illustrative, but not exhaustive, of the scope of the invention.

U.S. Provisional Applications No. 62/503,003 filed May 8, 2017, and No. 62/514,266 filed Jun. 2, 2017, PCT application PCT/US/2018/31602 filed May 8, 2018, and PCT Application No. PCT/US2018/035671 Filed Jun. 1, 2018 relate to cryptographic protection for vehicle authentication and computing environments, respectively. Each of these applications is herein incorporated by reference in its entirety for all purposes.

Onboard vehicle data and V2X communication data and protocol is used to provide position, direction, speed, and the state of surrounding vehicles and infrastructure nodes such as traffic lights. In embodiments, data internal to the vehicle is recorded to a black box style data recorder. In the event of an incident, the vehicles involved query the surrounding V2X sensors in the vicinity. In embodiments, the data offloaded from these other sensors, combined with geographic and map data such as Google Maps, Google Earth, LIDAR street representations, and the native vehicle black box data is used to recreate the incident in 2D or 3D via automated software processing for assignment of responsibility or fault. Integration of personal history such as arrest and conviction records, driver history, vehicle recall data, vehicle accident history and/or vehicle maintenance status is added to this database in embodiments for determination of responsibility or fault assignment and risk assessment. Vehicles without V2X capability are noted when possible. For example, embodiments, use onboard LIDAR from self-driving vehicles and onboard sensor data from non-self-driving vehicles (such as sensors for adaptive cruise control and parking assistance) to assist in mapping/identification of an obstruction. Embodiments apply cryptographic protections to all data to validate authenticity.

Embodiments provide a system and method for incident reconstruction comprising sending and receiving V2X messages by at least one vehicle as it travels, as a nonlimiting example, via Dedicated Short Range Communications (DSRC); storing to non-volatile memory (NVM) all V2X data received and sent from a plurality of entities for a time period (optionally comprising a circular buffer), wherein the data comprises a plurality of entries; if an incident occurs sending a final request for data logs from any other V2X in the vicinity, wherein this comprises a protocol update; ensuring that the data logs are sent using a signed and encrypted protocol so that the originating entity can be determined; sending a request for other stationary V2X objects in the area to store off their data for the time period wherein this comprises a protocol update; recording black box data; combining the V2X data stored to entity NVM with native black box data recorded by the entity and store to a file; applying cryptographic protections to the file such that confidentiality, authenticity and integrity can be determined; downloading the file from each entity (or uploading via Over The Air (OTA) to cloud); using simulation software to recreate the incident in 2D or 3D; and determining responsibility or fault or circumstances from recreation results. In additional embodiments, the data is combined with other databases such as personal history comprising driving history, arrest and conviction records, financial record/credit score, plus vehicle recall history, vehicle repair history, vehicle accident history, terror watch list, and most wanted list.

Embodiments include the perspective of a first vehicle that has just driven through an intersection where an incident occurs, right behind the vehicle after it clears the intersection. The first vehicle was not involved, but the first vehicle may have ancillary data that would be of interest to reconstructing the accident. The ancillary data in the first vehicle is retained and then accessed at a later time for incident reconstruction. Embodiments employ a protocol update such that the intersection has a notification that there was an incident, and it transmits this notification to the vehicles which have just cleared the intersection, such that these vehicles are notified to upload their data to a database. In embodiments, the vehicle in the incident broadcasts an alert such that all nodes within a radius store off the data from the appropriate time period. In embodiments, the other vehicles and infrastructure propagate this information forward such that it arrives at the vehicles which have already cleared the intersection. Once a vehicle has stored off a file, it is later offloaded; this can include the case where a vehicle drives from the city center (where the incident was) to the country where there is no V2X or communications.

Embodiments of the method for incident reconstruction comprise the following steps. 1) The vehicle actively sends and receives V2X messages as it travels. In a nonlimiting embodiment this is via Dedicated Short Range Communications (DSRC), other protocols are used in other embodiments. 2) All V2X data received and sent from all entities for the last 90 seconds is stored in non-volatile memory (NVM). In embodiments this comprises a circular buffer. In slow speed local traffic this could be tens of entries. In high speed highway traffic this could be hundreds to thousands of entries. 3) In the event of an incident: i.) a final request for data logs is sent to any other V2X in the vicinity. In embodiments, this would be a protocol update to the V2X baseline specification. Embodiments ensure that those logs are sent using a signed and encrypted protocol so that their originating entity can be determined and the data only seen by trusted entities. ii.) A request for other stationary V2X objects in the area to store off their last 90 seconds of data is also sent. In embodiments this would be a protocol update. Note that when requested data is stored off, it is recorded in such a manner that the cryptographic signature from the origin is maintained. iii.) request V2X data from entities which may have been in the vicinity, but have since moved; this propagation of the message represents a protocol update. iv.) Record black box data on incident vehicle(s). 4) Following the post-incident data gathering, combine the V2X data stored to vehicle NVM with native black box data recorded by the vehicle and store to a file. 5) Apply cryptographic protections to the file such that the confidentiality (optionally), authenticity, and integrity can be determined. These protections must be applied prior to file download off the vehicle. Not only does the cryptographically signed data from the V2X data offloaded from other sensors have to be maintained, but all data being offloaded from the vehicle with connection to the incident has to, at least, be signed to verify authenticity and integrity. 6) Download the file from each vehicle (or upload via OTA to the cloud). 7) Use simulation software to recreate the accident in 2D or 3D. In embodiments, there is a step of analyzing ongoing data to determine if an incident has occurred such as braking inputs, steering inputs, loss of a sensor input, or other similar data. In other embodiments, there is a step of analyzing incident data to determine if the incident is to be classified as an accident such as accelerometer data, air bag deployment sensors, or activation of the emergency services request through satellite/cellular infotainment systems. For embodiments, always connected entities provide data continuously that is automatically analyzed. In further embodiments, reliable, trusted, data from always-connected entities comprises blockchain technology. Some embodiments do not use blockchain to protect end user privacy. However, employing blockchain technology for a driverless mobility service or a delivery drone can support assured tracking of the location of the entity, as blockchain is a cryptographically protected, modification resistant, distributed ledger providing an open history of events and transactions. For continuing examples, a drone with V2X that is always cellular-connected (limited only by altitude), addresses electronic tail number tracking interests from homeland security and the FAA in addition to sending Automatic Dependent Surveillance-Broadcast (ADS-B) position reporting. The FAA Registry is a source that maintains aircraft tail number tracking data.

Embodiments are cryptographically verifiable and automated. They do not rely on individuals' memories or traditional forensic accident reconstruction methods.

Embodiments employ the functionality of the vehicle to not only record, but then offload, the data post-accident. Privacy concerns with the offload and sharing of this data are addressed by the confidentiality of encryption. Particularly, utilization of secure V2X infrastructure nodes, such as those stationed at intersections as the data recording devices helps to mitigate some vehicle functionality and privacy concerns. However, in supporting confidentiality, a step may be included where participants may need to ‘opt in’ to share their data.

In embodiments, as a function of the back-end processing of the incident data, automatic as mentioned, responsibility or at-fault determination can be made, and V2X data can be combined with other databases such as personal history comprising driving history, arrest and conviction records, financial record/credit score, plus vehicle recall history, vehicle repair history, vehicle accident history, terror watch list, and most wanted list.

Air and maritime vehicles are also candidates for implementation of embodiments. They currently have black boxes, to which the cryptographic protections can be applied. Consumer and delivery drones are also candidates. Both regulators and owners have a vested interest in cryptographically verifiable aircraft location when there is an incident (delivery drone incident with a passenger aircraft, recipient's delivery location, or house, or the power lines by the house, or a person as the package is delivered).

Modern vehicles have numerous sensors that collect data that includes items such as location, direction, speed, and inputs from throttle, brake, and steering wheel, and may eventually require black box data storage. Newer vehicles have even more sensors and can collect accessory details (e.g., air conditioner active), Bluetooth component activity, mobile phone activity, driver assisted alerting, and the like. For embodiments this information is utilized, in conjunction with similar data from other vehicles, to assist in incident recreation. There is confidence that the code running in the vehicle generating those values is authentic due to the implementation of encryption and signature verification, including as described in U.S. Provisional Applications 62/503,003 and 62/514,266, and PCT applications PCT/US2018/035671 and PCT/US/2018/31602. With the implementation of cryptographic verification of vehicle authenticity, the entity can be verified as authentic via cryptographic protections. Thus, the code running in that entity, and the values generated by that entity can be trusted as authentic.

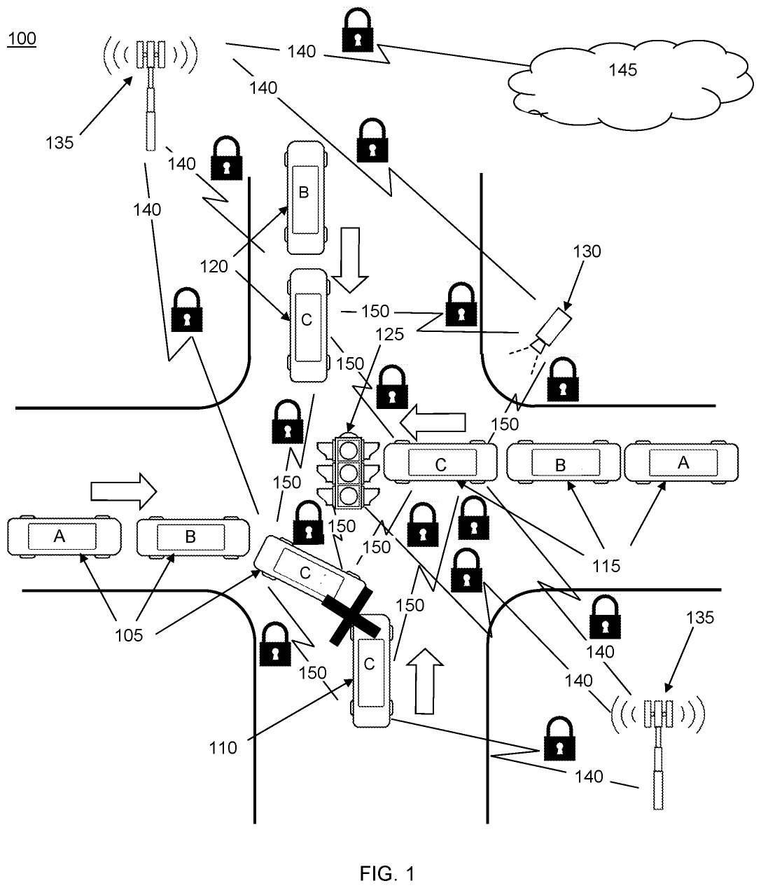

FIG. 1 depicts an incident reconstruction data collection environment 100 utilizing V2X communications comprising a first vehicle 105, second vehicle 110, third vehicle 115, and fourth vehicle 120. Note time-sequential positions of each for times A, B, and C. Included in the environment are traffic light 125, intersection camera 130, and one or more communication antennas 135. Each device has a secure V2X communications link 140 with at least one communication antenna 135. Additionally, a secured communication link 140 exists to cloud communications 145. In addition to the communication links to communication antennas 135 are shown, secure V2X communications directly between vehicles/devices 150 are also shown.

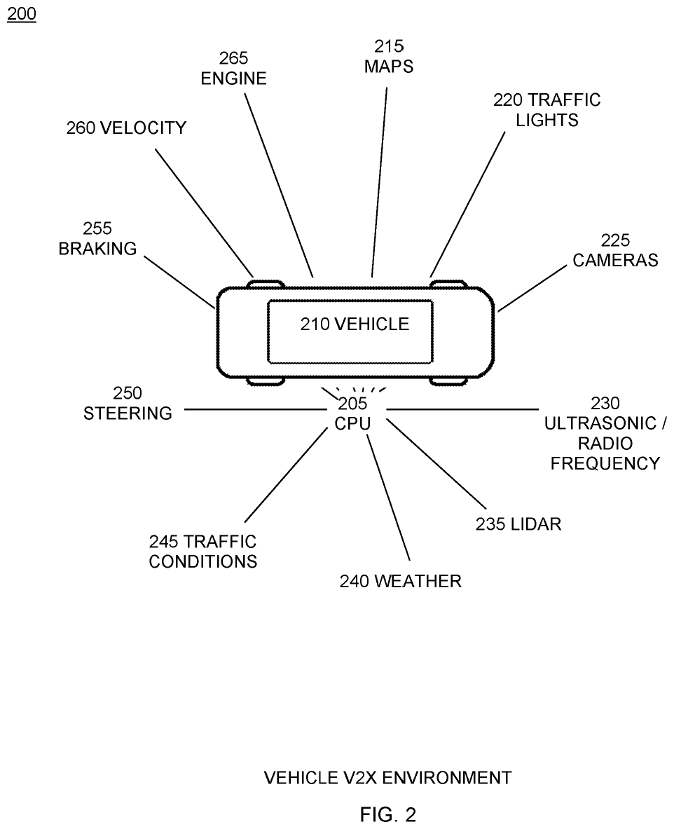

FIG. 2 depicts a generalized vehicle V2X environment 200. CPU 205 of vehicle 210 interfaces with internal and external sources of data for incident reconstruction. Examples of sources include maps 215, traffic light(s) 220, camera(s, on or off-board vehicle) 225, ultrasonic/radio frequency 230, LIDAR 235, weather 240, traffic conditions 245, steering 250, braking 255, velocity 260, and engine parameters 265. Velocity 260 includes speed and direction. Note that some information is created by the vehicle, and some is from offboard. For example, traffic light(s) 220, camera(s) 225, weather 240, and traffic conditions 245, are incoming V2X data from infrastructure and other vehicles. In the case of weather 240 and traffic data, other entity resources such as satellite or cellular may provide data.

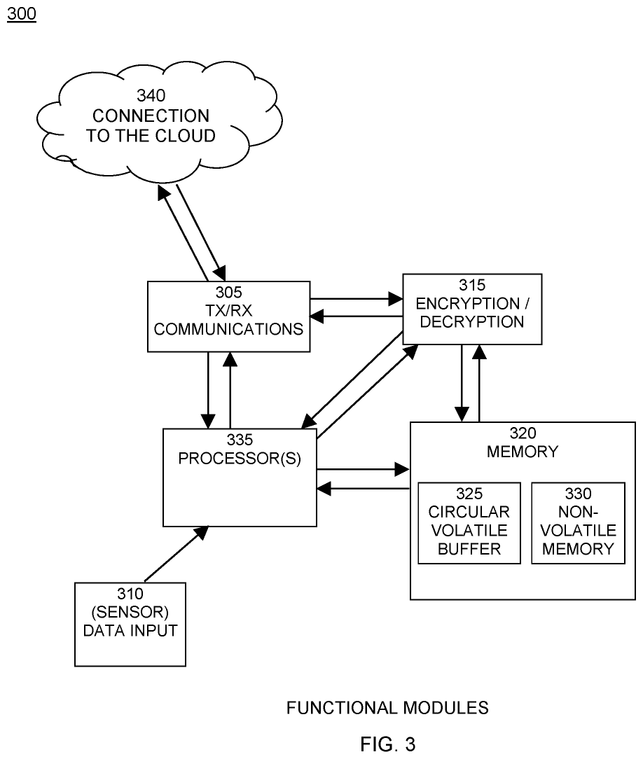

FIG. 3 depicts functional modules 300. Modules comprise transmit/receive communication module 305; data input (including from sensors) 310; encryption/decryption module 315; memory 320 optionally comprising circular volatile buffer 325 and non-volatile memory 330. Processor(s) 335 communicates with transmit/receive communication module 305; encryption/decryption module 315; data input (including from sensors) 310, and memory 320. Transmit/receive communication module 305 also communicates with the cloud through connection to the cloud 340. These modules depict the functional modules for the vehicle offloading post-incident data to the cloud. Each V2X contributing device incorporates this structure to provide communications between nodes.

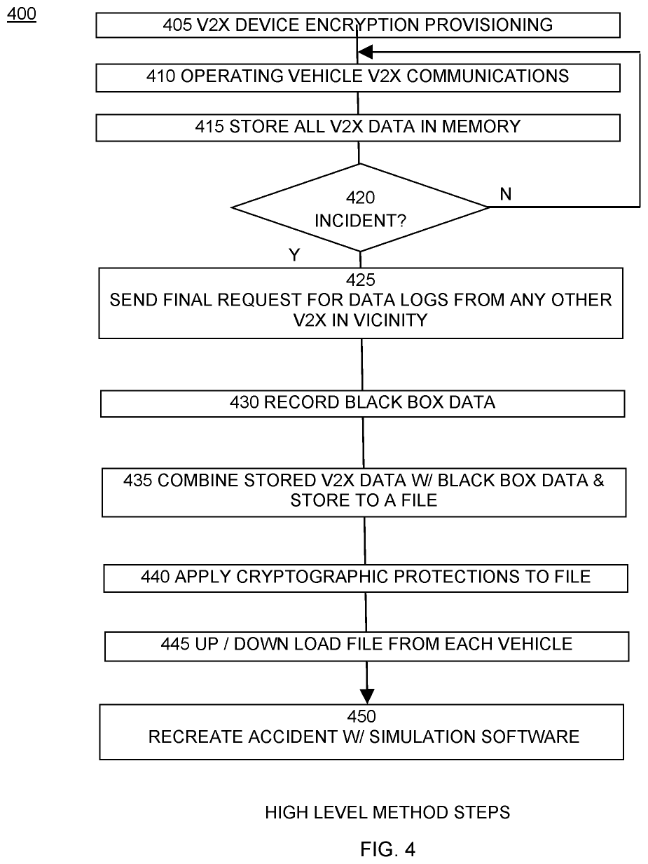

FIG. 4 depicts high level method steps 400. Steps comprise V2X device encryption provisioning 405; operating vehicle V2X communications 410; storing all V2X data in memory 415; if incident 420; sending a final request for data logs from any other V2X in vicinity 425; recording black box data 430; combining stored V2X data w/black box data & storing to a file 435; applying cryptographic protections to file 440; up/down loading the file from each vehicle 445; recreating the incident with simulation software 450. In one example the recreation is in 3D. In another example the recreation is in 2D. In one embodiment, reconstruction is used to establish responsibility or fault determination. The data could be provided to insurance companies, law firms, law enforcement agencies, and similar, and in one example would be a fee based license for the data. In another scenario, the data would be used to recreate the incident and the recreated model would be licensed to the user. Not all these process features are sequential, and they are not required to be processed on a single computing resource. For example, the cryptographically protected files from the various vehicles can be stored on a server that is later accessed and retrieved for the recreation. The recreation should provide sufficient data to determine the details of the incident and the root cause analysis. In a further example, the reconstruction can be augmented by data from other resources such as street sensors/cameras, building sensors/cameras, satellite imagery and the like.

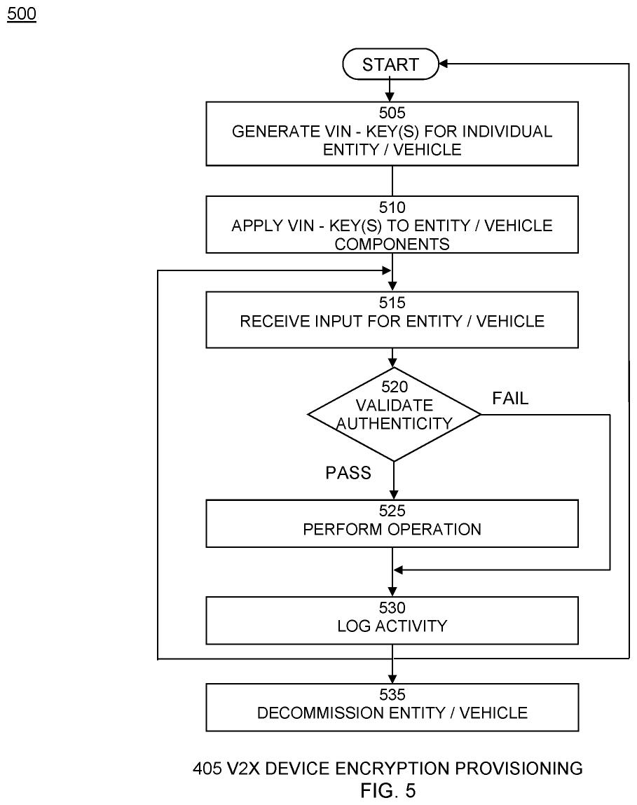

FIG. 5 is a detail sub-figure flowchart 500 of one embodiment for V2X device encryption provisioning step 405 in FIG. 4. The V2X device encryption provisioning process comprises generating a (Vehicle) Identification Number (VIN)—Key(s) for an individual entity/vehicle 505. In one example, this is performed during the manufacture of the entity/vehicle and the installation of the components. In another example, the generation of the VIN—Key(s) is performed on operational entities/vehicles as a service. In both examples, the encryption provisioning process employs a priori digital certificates signed by a trusted certificate authority as documented by PCT/US2018/031602 dated 8 May 2018 and incorporated herein. Applying the VIN—Key(s) to the entity/vehicle components by storing the Keys in some form of protected non-volatile memory 510. In both examples, the VIN—Key(s) must be applied and signed by a trusted source. Once the VIN—Key(s) is applied to the entity/vehicle components, it provides an un-mutable mechanism to uniquely identify the components. New components can be added, and the VIN—Key(s) would be applied to the new components. Receive input for the entity/vehicle 515 such as updates, commands, instructions or information that is intended to be stored and/or processed by one or more processing units and one or more memory components. Validate authenticity of the input and entity/vehicle 520. This ensures that the input designated to one or more components is from a trusted source and has not been exploited or otherwise corrupted. If validated, the system performs the operation by allowing the input to proceed to one or more components 525. If not validated, the system does not allow the input to proceed to the components and does not perform the operation. A log of activity 530 is generated to provide an audit trail and in one example includes attributes such as a time stamp, name of the input file/descriptor, and intended destination component. In one example, the process of receiving inputs 515, validating authenticity 520, performing operations 525 and logging activity 530 is repeated for each input or series of inputs. At end of life of the entity/vehicle, the system decommissions the entity/vehicle 535. In a further example, the entire input and component history can be retrieved providing a complete log for the entity/vehicle. Such data can be used, for example, in the described incident reconstruction, personal injury actions, recalls, and the like. While a VIN is used in this example, any unique identifier can be used such as a drone manufacturer serial number, a fixed camera light internet protocol address, and similar forms of unique addresses.

In other embodiments, as documented by PCT/US2018/035671 and incorporated herein, details for the step of an embodiment for split key device encryption provisioning comprise generating a strong master secret; splitting the master secret resulting in multiple keys which are placed in multiple modules; distributing and storing shares; and logging activities. In embodiments, the multiple modules comprise at least the V2X module and the vehicle CPU. Alternate embodiments provision using public private key pairs where the pieces of public or private keys may be split.

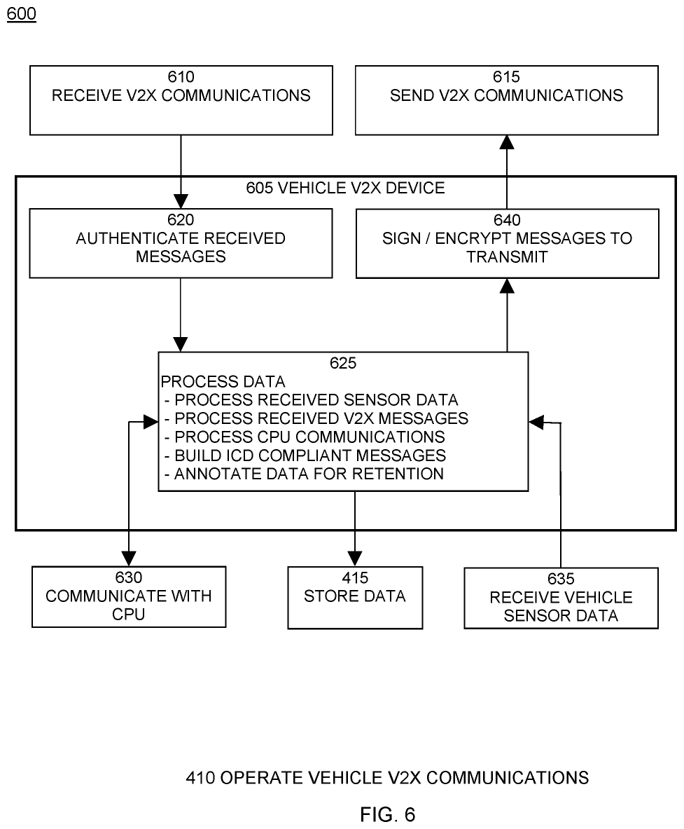

FIG. 6 is a detail sub-figure flowchart 600 of step 410 in FIG. 4. It is a high level block diagram 600 of components of an operating vehicle V2X device in a securely configured V2X communications environment. Depicted is the V2X device 605. In embodiments, the V2X device communicates with other V2X devices by receiving communications from them 610, and sending communications to them 615. V2X data received from external V2X devices is verified to be authentic 620. In one embodiment this is via a public/private key infrastructure based on a trusted certificate authority hierarchy. In another embodiment this is based on blockchain technology. Messages which cannot be verified as authentic are discarded. The received messages determined to be authentic, and the data they contain is processed 625. As part of this step, the vehicle sensor data and V2X messages are processed in accordance with the embodiment, and outgoing V2X messages are created for transmission. Relevant data is either communicated to the vehicle CPU 630, stored 415, or added to outgoing V2X messages to be transmitted or propagated 640. Vehicle sensor data is received from the vehicle 635 and processed to be added to outgoing V2X messages. These outgoing messages are signed or encrypted and signed 640 to ensure authenticity and integrity. In one embodiment this is via a public/private key infrastructure based on a trusted certificate authority hierarchy. In another embodiment this is based on blockchain technology. Once the messages have been encrypted/signed they are transmitted out of the V2X device for receipt by other V2X devices 615.

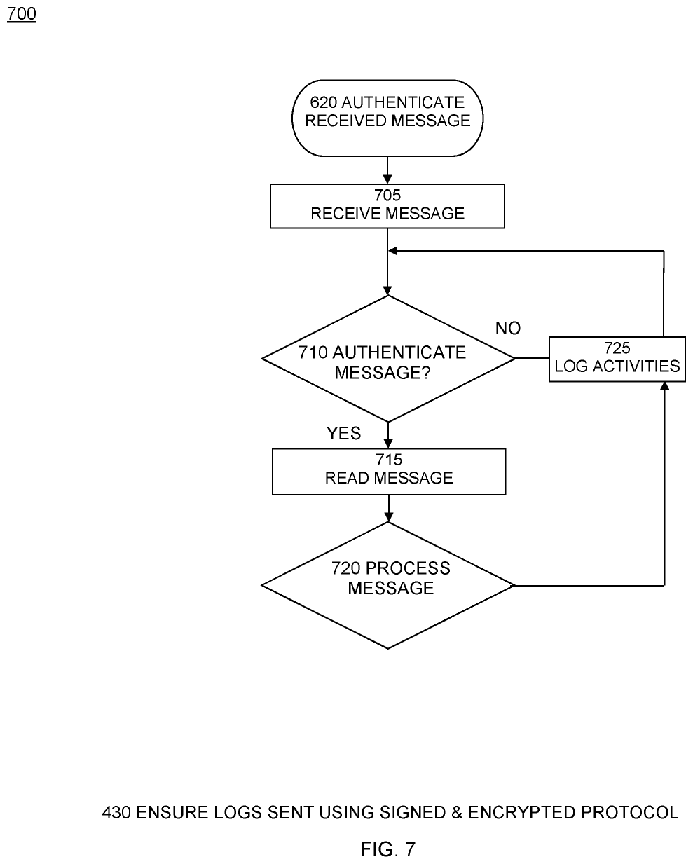

FIG. 7 is a detail sub-figure flowchart 700 of step 620 in FIG. 6. Details for the authentication step ensure the V2X communications are sent from an authentic source and have genuine contents. Messages are received 705 from external V2X devices. The messages and their contents are authenticated 710. In one embodiment this is via a public/private key infrastructure based on an a priori trusted certificate authority hierarchy. In a second embodiment this is based on blockchain technology. If the message and its contents are authentic, read the message 715 for use by the vehicle V2X device for further processing 720 or storage. If the message or its contents are not authentic, discard it and log activities 725. Logging of activities 720 is conducted as necessary for authentic messages.

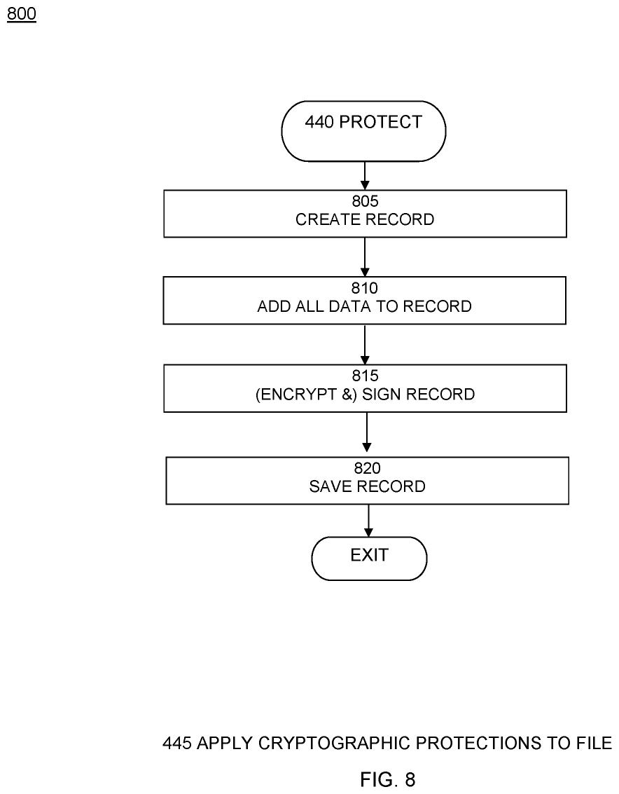

FIG. 8 is a detail sub-figure flowchart 800 of step 440 in FIG. 4. Details for the step of applying cryptographic protections to file 440 comprise creating record 805; adding all data to record 810; (encrypt and) sign record 815; and save record 820. For embodiments, the record would include an ID number, date, user/owner, and description of the operations. In embodiments that encrypt and sign record 815, the confidentiality, authenticity, and integrity of logged data is protected via encryption and digital signature. In one embodiment, the authenticity, integrity and confidentiality of the data is protected via public/private key infrastructure based on an a priori trusted certificate authority hierarchy. In a second embodiment the authenticity and integrity of the data is based on blockchain technology. In a third embodiment, the authenticity, integrity, and confidentiality of the data is protected via split keys. In this embodiment, the encryption and signing of the file is based on symmetric keys which are split between multiple devices such as the V2X device, the vehicle CPU, and the vehicle user's smartphone as documented by PCT/US2018/035671. The use of split keys internal to the vehicle or between the vehicle and a device paired with the vehicle offers the highest level of data protection. However, if those same split keys are used for data offloaded to the cloud, especially in this case of automated data analysis, key management complexities arise due to the number of keys involved and their storage locations (vehicles, sensors, smartphones, cloud, and others). In embodiments, PKI and blockchain have more protection advantages for the data that is external to the vehicle and to which third parties need access.

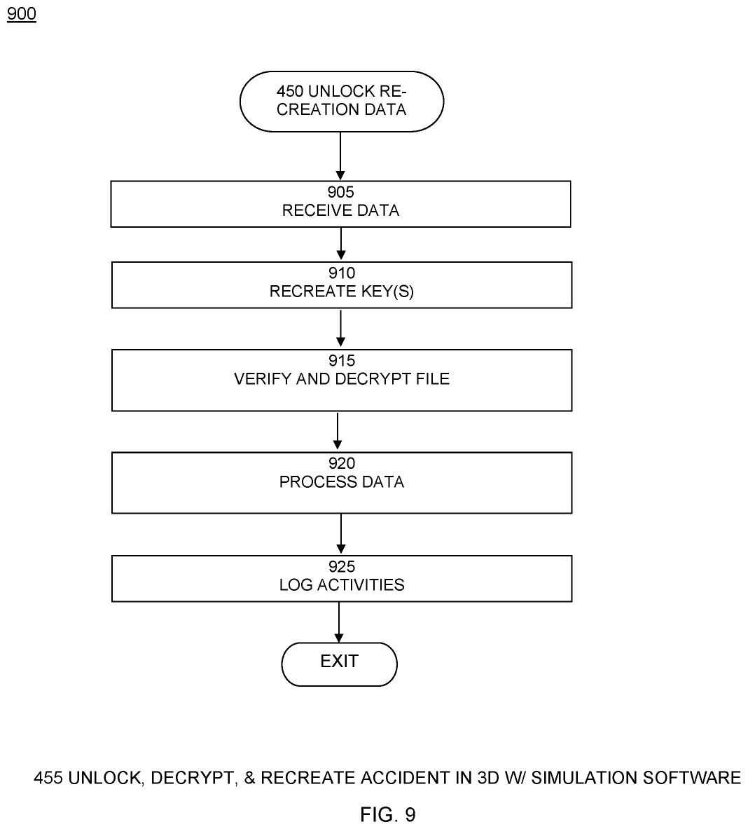

FIG. 9 is a detail sub-figure flowchart 900 of step 450 in FIG. 4. Details for the step of unlocking re-creation data 450 comprise receiving data 905; recreating key(s) and/or receiving keys 910; verifying and decrypting file 915; processing data 920; and logging activities 925. Embodiments comprise multiple keys. PKI or symmetric implementations comprise unique signature and encryption keys. Note that the signature of the file is first verified to ensure it is authentic, once proven authentic, it is then decrypted. While a subtlety, this is technically important. Failure to first check that the signature is authentic expands the attack surface against the security implementation.

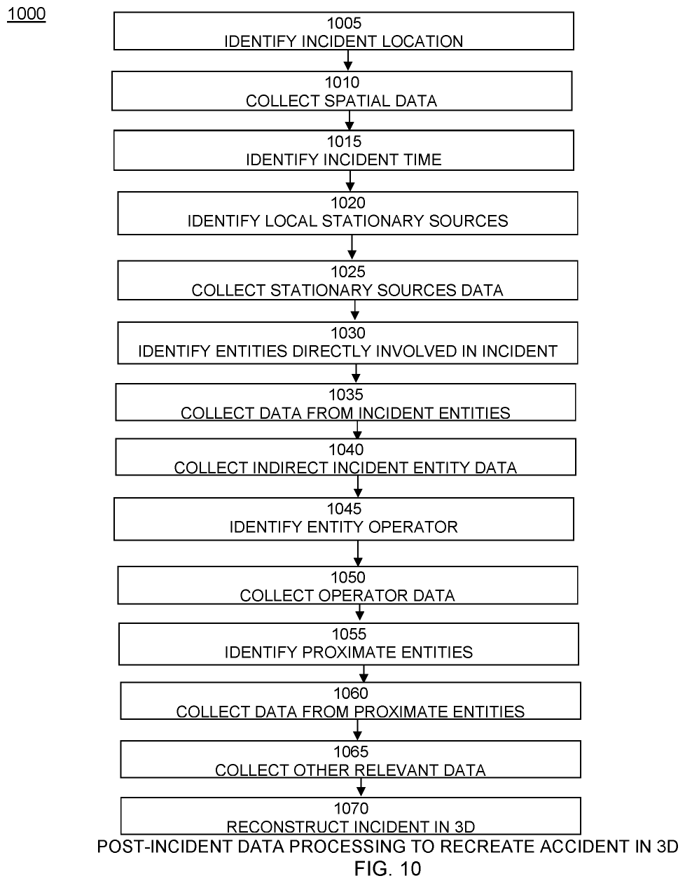

FIG. 10 is a detail sub-figure flowchart 1000 of processing step 920 in FIG. 9 for processing data after an incident to recreate the incident in 2D or 3D in accordance with an embodiment. Steps comprise: identifying the incident location 1005; collecting incident location spatial data such as maps 1010; identifying the incident time 1015; identifying local stationary sources 1020; collecting data from the local stationary sources 1025; identifying incident entities directly involved in the incident 1030; collecting data from the incident entities directly involved in incident 1035; collecting indirect incident entity data such as recall history 1040; identifying incident entity operator 1045; collecting incident entity operator personal history data 1050; identifying mobile entities proximate at time of the incident 1055; collecting data from the mobile entities proximate at time of the incident 1060; collecting other relevant data 1065; and reconstructing the incident in 2D or 3D from the collected data 1070. Multiple iterations of this process may be executed to complete the process of incident reconstruction if additional data becomes available at different times.

While the following example is implicit from the combination of other Figures, it is provided for additional clarification. The scenario implements a method embodiment for incident reconstruction utilizing V2X communications. Three individuals and their associated vehicles are involved in a minor accident at an intersection. The individual ultimately responsible (User_3) for the accident flees the scene. The other two individuals (User_1 and User_2) contact their insurance companies to initiate repairs. The insurance companies have a vested interest in the responsible party paying for the repairs. As a result of the accident occurring, all three vehicles store off their local vehicle black box data. The vehicles also request V2X sensor data from other entities in the vicinity (other vehicles, traffic lights, traffic cameras, etc.) and store that data. Data is transmitted to them either via DSRC V2X at the time of the event, or by cellular or wireless after the event via message propagation through the cloud and a trusted third party data service. User_1 and User_2 voluntarily transmit their cryptographically verifiable black box data, as well as the data from the other entities to a trusted third party via cellular connections at the time of the event. The trusted third party has access to additional data such as vehicle maintenance history, driver identity, driving history, arrest record, terror watch list, etc. The trusted third party inputs the data into the automated processing software. This software utilizes the verifiably authentic data collected from the entities to determine the time, place, and individuals involved in the accident. The third party then may request additional sensor data from that time and location if available as well as parse other databases for relevant data. The software recreates the incident in 2D or 3D to provide visualization of the event for review. The software also makes a determination of responsibility or fault. Results are reported to the insurance company. In this example, the automated software is able to determine the at fault individual (User_3) from a combination of V2X data offloaded by local infrastructure (traffic lights and cameras) and the data offloaded from the vehicles of User_1 and User_2. When provided the opportunity to refute the results of the automated processing software, User_3 provides black box data and V2X data for analysis via a wireless connection between their vehicle and home to a trusted third party. The trusted third party shows the data is invalid because User_3 provided black box data from a fourth (not involved in the incident) vehicle and the cryptographic authentications for the data are invalid and do not match those recorded by the other vehicles involved in the accident or that of the infrastructure V2X devices. This embodiment prevents the inclusion of falsified data in the automated analysis and assignment of fault.

Embodiments include, in the Interface Control Document (ICD), a method to authenticate and decrypt the data in the cloud based on key management techniques. In embodiments, full key, unencrypted, vehicle black box data and any V2X data only execute in volatile memory regions of the CPU such that a power cycle clears user data.

The computing system used for cryptographically verified and automated gathering and communication of incident related data for incident recreation and responsibility or fault assignment described hereinabove with respect to the system and/or the method may include a processor, FPGA, I/O devices, a memory system, and a network adaptor. The computing system includes a program module (not shown) for performing (or controlling) the operations or functions described hereinabove with respect to the system and/or the method according to exemplary embodiments. For example, the program module may include routines, programs, objects, components, logic, data structures, or the like, for performing particular tasks or implement particular abstract data types. The processor may execute instructions written in the program module to perform (or control) the operations or functions described hereinabove with respect to the system and/or the method. The program module may be programmed into the integrated circuits of the processor. In an exemplary embodiment, the program module may be stored in the memory system or in a remote computer system storage media.

The computing system may include a variety of computing system readable media. Such media may be any available media that is accessible by the computer system, and it may include both volatile and non-volatile media, removable and non-removable media.

The memory system can include computer system readable media in the form of volatile memory, such as random access memory (RAM) and/or cache memory or others. The computer system may further include other removable/non-removable, volatile/non-volatile computer system storage media. The computer system can communicate with one or more devices using the network adapter. The network adapter may support wired communications based on Internet, LAN, WAN, or the like, or wireless communications based on CDMA, GSM, wideband CDMA, CDMA-2000, TDMA, LTE, wireless LAN, Bluetooth, or the like.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++ or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to a flowchart illustration and/or block diagram of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The foregoing description of the embodiments has been presented for the purposes of illustration and description. It is not intended to be exhaustive or to limit the invention to the precise form disclosed. Many modifications and variations are possible in light of this disclosure. It is intended that the scope of the present disclosure be limited not by this detailed description, but rather by the claims appended hereto.

A number of implementations have been described. Nevertheless, it will be understood that various modifications may be made without departing from the scope of the disclosure. Although operations are depicted in the drawings in a particular order, this should not be understood as requiring that such operations be performed in the particular order shown or in sequential order, or that all illustrated operations be performed, to achieve desirable results.

Each and every page of this submission, and all contents thereon, however characterized, identified, or numbered, is considered a substantive part of this application for all purposes, irrespective of form or placement within the application. This specification is not intended to be exhaustive or to limit the invention to the precise form disclosed. Many modifications and variations are possible in light of this disclosure. Other and various embodiments will be readily apparent to those skilled in the art, from this description, figures, and the claims that follow. It is intended that the scope of the invention be limited not by this detailed description, but rather by the claims appended hereto.

What is claimed is:

1. A system for cryptographically verifiable and authenticated entity incident reconstruction comprising:
sending and receiving communication data (140, 150) by at least one transceiver device (305) on one or more entities (105, 110, 115, 120, 125, 130, 410);
storing, in at least one memory storage device (320), data received and sent from said entities for a time period, wherein said data comprises a plurality of entries (415);
upon occurrence of an incident (420) at an incident location at an incident time involving at least one incident entity:
sending a final request for data logs from at least one other communication-connected entity in a vicinity of said incident (425);
if there are data logs, processing said data logs from said at least one other communication-connected entity, wherein said data logs are sent using at least one of a signed and encrypted protocol whereby an originating entity can be determined (410);
sending a request for stationary communication-connected entities in said vicinity to store off their data, if any, for a final request time period;
storing all said data and data logs in said at least one memory storage device with said recorded data and storing to a file (435) in memory;
applying cryptographic protections to said file such that confidentiality, authenticity and integrity can be determined (440);
downloading said file from each said entity (445); and
using simulation software with said file from each said entity, recreate said incident (450).

2. The system for cryptographically verifiable and authenticated entity incident reconstruction of claim 1, wherein, said data is combined with other databases comprising at least one of most wanted list, terror watch list, driving history, arrest and conviction records, financial record/credit score, vehicle recall history, vehicle repair history, and vehicle accident history.

3. The system for cryptographically verifiable and authenticated entity incident reconstruction of claim 1, wherein said entity is at least one of a vehicle (210), a drone, an aircraft, a vessel, and a stationary object (125, 130).

4. The system of claim 1, wherein said data comprises vehicle to everything (V2X) communications (140), and said sending and receiving comprises Dedicated Short Range Communications (DSRC).

5. The system for cryptographically verifiable and authenticated entity incident reconstruction of claim 1, comprising a step of device encryption provisioning (405) comprising:
generating an Identification Number—Key for one or more entities (505);
applying said Identification Number—Key to components of said one or more entities (510);
receiving input for said one or more entities (515);
validating authenticity of at least one of said input and said one or more entities (520);
performing operation of said input if validated (525); and
logging said operation (530), whereby said authenticity of said one or more entities is immutable and cryptographically verified.

6. The system for cryptographically verifiable and authenticated entity incident reconstruction of claim 1, wherein said step of sending and receiving data by at least one transceiver device on at least one said entity (410) comprises:
operating a vehicle's vehicle to everything (V2X) key management in a securely configured V2X communications environment comprising:
a vehicle V2X device (605) communicating with other V2X devices by receiving communications from said other V2X devices (610);
said vehicle V2X device (605) further communicates with said other V2X devices by sending communications to said other V2X devices (615);
said V2X data received from external V2X devices is verified to be authentic (620);
data which cannot be verified as authentic are discarded, if received data is determined to be authentic, said V2X data they contain is processed (625);
said V2X data is either communicated to a vehicle CPU (630), stored (415), or added to outgoing V2X messages to be transmitted or propagated (640).

7. The system for cryptographically verifiable and authenticated entity incident reconstruction of claim 1, wherein said step of ensuring, at said at least one other communication-connected entity, that said data logs are sent using at least one of a signed and encrypted protocol whereby an originating entity can be determined (410) comprises:
receiving messages from external V2X devices (705);
authenticating messages (710);
if said message or its contents are not authentic, discard it and log activities (725);
if said message and its contents are authentic, read said data (715) for use by the vehicle V2X device for further processing (720) or storage.

8. The system for cryptographically verifiable and authenticated entity incident reconstruction of claim 1, wherein said step of applying cryptographic protections to said file such that confidentiality, authenticity and integrity can be determined (440) comprises:
creating a record (805);
adding all data to said record (810);
encrypting and signing said record (815); and
saving said record (820), whereby the confidentiality of logged data is protected.

9. The system for cryptographically verifiable and authenticated entity incident reconstruction of claim 1, wherein applying cryptographic protections to said file such that confidentiality, authenticity and integrity can be determined (445) comprises:
receiving data (905);
recreating at least one key (910);
decrypting and verifying file (915);
processing data (920); and
logging activities (925).

10. The system for cryptographically verifiable and authenticated entity incident reconstruction of claim 1, further comprising a step of:
opting-in by a controller of a respective entity to share said data.

11. The system for cryptographically verifiable and authenticated entity incident reconstruction of claim 1, wherein said step of storing (415) comprises:
non-volatile memory (NVM) (330) and a circular volatile buffer (325).

12. The system for cryptographically verifiable and authenticated entity incident reconstruction of claim 1, further comprising recording black box data from at least one of the incident entity and the communication-connected entity in a vicinity of said incident.

13. The system for cryptographically verifiable and authenticated entity incident reconstruction of claim 1, wherein said downloading said file from each said entity (445) comprises an upload via Over The Air (OTA) to a cloud (340).

14. The system for cryptographically verifiable and authenticated entity incident reconstruction of claim 1, wherein said vicinity of said incident is defined as a line of sight distance from said incident location to each said stationary entity within a line of sight of said incident location, and for each mobile said entity, a distance from a said incident location to each said mobile entity within a line of sight of said incident at said incident time; and
said step of using simulation software with said file from each said entity, recreate said incident (450) comprises 2D or 3D.

15. A method for cryptographically verifiable and authenticated entity incident reconstruction comprising:
sending and receiving communication messages by at least one said entity (410);
storing (320) all data received and sent from a plurality of said entities for a time period, wherein said data comprises a plurality of entries (415);
upon occurrence of an incident (420) at an incident location at an incident time involving at least one incident entity:
sending a final request for data logs from at least one other communication-connected entity in a vicinity of said incident (425);
ensuring, at said at least one other communication-connected entity, that said data logs are sent using at least one of a signed and encrypted protocol whereby an originating entity can be determined (410);
sending a request for stationary communication-connected entities in said vicinity to store off their data for a final request time period;
combining said all data stored in said at least one memory storage device with said recorded data and storing to a file (435) in memory;
applying cryptographic protections to said file such that confidentiality, authenticity and integrity can be determined (440);
downloading said file from each said entity (445); and
using simulation software with said file from each said entity, recreate said incident in 2D (450).

16. The method of claim 15, wherein said incident occurrence comprises:
at least one of
a designation by an operator of an entity; or
an accident.

17. The method of claim 15, wherein said incident occurrence (420) comprises an accident indicated by damage indicated by a signal designating a deployment of an airbag.

18. The method of claim 15, wherein said incident entity is at least one said entity directly associated with said incident.

19. The method of claim 15, further comprising:
determining fault or circumstances from said incident recreation results,
wherein said at least one incident entity is at least one entity sustaining damage at about said incident location at about said incident time.

20. A system for cryptographically verifiable and authenticated entity incident reconstruction comprising:
sending and receiving communication messages by at least one transceiver device on at least one said entity (410);
storing, in at least one memory storage device (320) on each said entity, all data received and sent from a plurality of said entities for a time period, wherein said time period is in a range of about 30 to 120 seconds before and after said incident time, and wherein said data comprises a plurality of entries (415);
said data comprising a plurality of data relating to maps (215), traffic lights (220), cameras (225), ultrasonic/radio frequency (230), LIDAR (235), weather (240), traffic conditions (245), steering (250), braking (255), velocity (260), and engine parameters (265);
upon occurrence of an incident (420) at an incident location at an incident time involving at least one incident entity:
sending, by said incident entity, a final request for data logs from at least one other communication-connected entity in a vicinity of said incident (425);
ensuring at said at least one other communication-connected entity, that said data logs are sent using at least one of a signed and encrypted protocol whereby an originating entity can be determined (410);
sending a request for stationary communication-connected entities in said vicinity to store off their data for a final request time period, wherein said final request time period is in a range of about 30 to 120 seconds before and after said incident time;
combining said all data stored in said at least one memory storage device with said recorded data logs and storing to a file (435) in memory wherein said data stored to memory is contained in said final request data logs;
applying cryptographic protections to said file such that confidentiality, authenticity and integrity can be determined (440);
downloading said file from each said entity (445) wherein said downloaded file comprises data stored off from stationary entities; and
using simulation software with said file from each said entity, recreate said incident (450).
